(19) United States
(12) Patent Application Publication
(10) Pub. No.: US 2008/0034308 A1
(43) Pub. Date: Feb. 7, 2008

(54) System and method for displaying a variable status

(75) Inventors: Oliver Heise, Neumarkt (DE); Bernhard Jany, Wendelstein (DE); Thilo Opaterny, Nurnberg (DE); Dietmar Schulz, Rosstal (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/879,314

(22) Filed: Jul. 17, 2007

(30) Foreign Application Priority Data
Aug. 1, 2006 (EP) 06016046.2

(51) Int. Cl. G06F 3/048

(52) U.S. Cl. 715/764

(57) ABSTRACT

System for displaying status values for variables, with the variables being provided for use by one or more modules, in particular modules which represent the components of an automation system, having at least one usage point display, which is provided to specify the modules using said variables, selection means for selecting at least one variable from the usage point displays by a user of the system and display means for displaying the status values, which the at least one variable is adopting in the modules using said variable.

The invention relates to a system and a method for displaying status values for variables, with the variables being provided for use by one or more modules.

Within the scope of the engineering of an automation solution, special modules are used for specific functions of the engineering system. In such cases the modules are represented in the engineering system by code. The modules use different variables, with the variables being able to adopt different status values. In these situations a variable can be used by a number of modules and can adopt different values over the course of time within the different modules at the points at which said variable is used.

Within the scope of the engineering, it is extremely difficult to identify in the module status of an individual module which other modules are writing which values into a particular variable and/or reading values from this variable. So-called usage points are currently used to indicate where a specific variable is used in read or write form. This information is however only shown statically. The usage points are shown in such cases in table form for the user of the engineering system. However there is no indication to the user of the system as to which values the corresponding variables are adopting at the points used.

The object of the present invention thus consists make it possible for the user to display the current status values of variables.

The object is achieved in accordance with the invention by a system for displaying status values of variables, with the variables being provided for use by one or more modules, in particular modules which represent the components of an automation system, having at least one usage point display, which is provided to specify the modules using the variables, selection means for selecting at least one variable from the usage point display by a user of the system and display means for displaying the status values which the at least one variable is adopting in the modules using said variable.

The object is further achieved by a method for displaying status values for variables, with the variables being used by one or more modules, in particular modules which represent the components of an automation system, with which the modules using the variables are specified by at least one usage point display, at least one variable is selected from the usage point display by a user of the system and the status values being adopted by the at least one variable in the modules using said variable are displayed.

The idea underlying the invention is that it is significantly advantageous for a project engineer and/or engineer, if he/she is able to display the status values which a variable is adopting in the different modules which use said variable. This clarifies to the user how a specific variable develops over the course of time.

In previously used systems the user would have to obtain detailed information concerning the current variable status and the trend of specific variables with the aid of break points, which interrupt the dynamics, or with the aid of statistical analyses.

With the system and method according to the invention, the current status values of the variables are however made available to the user in a simple manner. In this method the user selects specific variables for which he/she would like to have status values displayed. The points at which the variables are present in the modules by which they are used are determined. When using this method the user can select one or more variables for which he would like to have the current status values displayed. The values are then displayed at all usage points of the corresponding variables.

In such cases the status variables can be directly displayed at the usage points via which the user has also selected the variables. They can however also be written into an independent table and displayed therein.

The dynamics of the values of the variables are determined in the system according to the invention with the aid of code triggers. The code triggers report if a specific code address is run. The change in a value is then identified by a programming device, by comparing the values at the different code addresses with one another. The change in the variable status and/or the status values of the selected variables is herewith identified. If a corresponding variable changes at a point at which it is used, the current value is entered into the corresponding display for the current variable status. The user of the system is thus always dynamically supplied with current status values for the corresponding variables. He or she does not need to go to the individual usage points and look there for the current variable values.

The invention is described in more detail below with reference to the Figures in which;

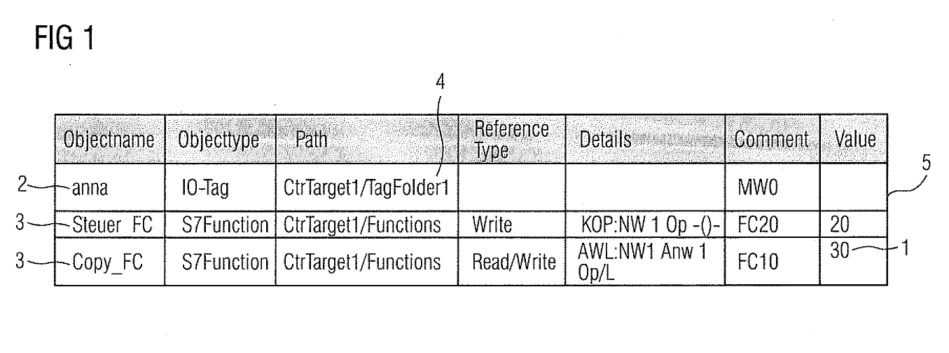

FIG. 1 shows the system for displaying status values 1 for variables 2. Specific variables 2 are used here in a number of modules 3 of the automation system. The corresponding usage points of the variables 2 in the modules 3 are specified by means of a usage point display 4. Furthermore, the system has display means 5 for displaying the status values 1, which the variables are currently assuming at the points at which they are used.

In the present example, the variable “Anna” is specified in the tables with its usage point and in the last column the corresponding status values 1 of the selected variable are displayed by way of the display means 5.

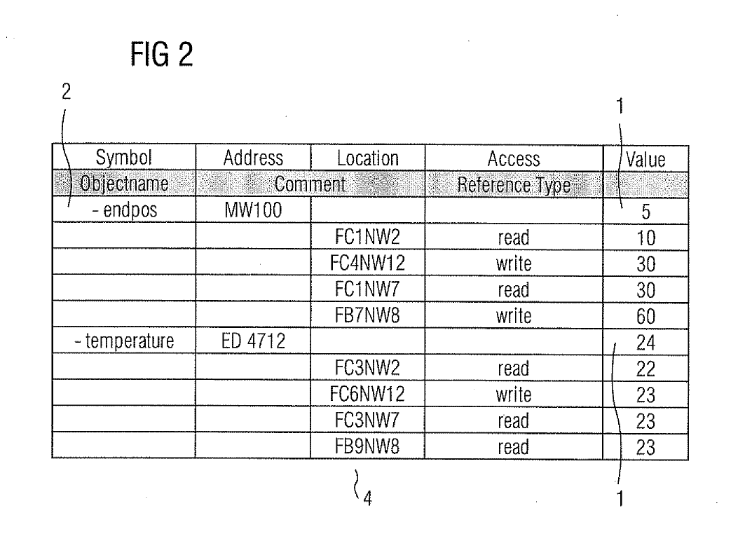

FIG. 2 shows a similar example, in which a somewhat different display format of the list is selected. The variables 2 contain a separate column (symbol), the address ‘location’ corresponds to the module 3 from FIG. 1 (FC stands for function, NW stands for network). The access or reference ‘type’ specifies whether the variable is accessed in this step in for reading or writing. Value designates the status value 1.

1.-10. (canceled)

11. A system to display status values for variables used for modules, comprising:
a usage point display to specify the modules using the variables;
a selection device to select at least one variable from the usage point displays by a user of the system; and
a display device to display the status values of the variable in the modules, wherein the status value of the variable is adopted to the modules using the variable.

12. The system as claimed in claim 11, wherein the variables are used by one or more modules.

13. The system as claimed in claim 12, wherein the modules represent components of an automation system.

14. The system as claimed in claim 13, wherein the usage point display displays the status values of the selected variable.

15. The system as claimed in claim 13, wherein the display device is an independent table.

16. The system as claimed in claim 13, wherein the selection device is a selection function.

17. The system as claimed in claim 13, wherein the selection device is a multiple selection function.

18. The system as claimed in claim 13, wherein the selection device is a selection function and a multiple selection function.

19. The system as claimed in claim 13, wherein code addresses are addressed based upon code triggers.

20. The system as claimed in claim 19, wherein the status values of a selected variable are determined based upon the code triggers.

21. A method to display status values for variables, comprising:
providing modules;
using the variables by at least one module;
specifying the modules using the variables by at least one usage point display;
selecting at least one variable from the usage point display by a user; and
displaying the status values of the variable in the modules using the variable.

22. The method as claimed in claim 21, wherein the modules represent components of an automation system.

23. The method as claimed in claim 22, wherein the status values of the selected variable are displayed via the usage point display.

24. The method as claimed in claim 23, wherein the status values of the selected variable are displayed based upon an independent table.

25. The system as claimed in claim 24, wherein the variables for the display of the status values are selected based upon a selection function.

26. The system as claimed in claim 24, wherein the variables for the display of the status values are selected based upon a multiple selection function.

27. The system as claimed in claim 24, wherein the variables for the display of the status values are selected based upon a selection function and a multiple selection function.

28. The method as claimed in claim 21, wherein the status values of the selected variable are determined based upon a code of the modules and based upon a code trigger.
